(19) United States
(12) Patent Application Publication
(10) Pub. No.: US 2016/0003733 A1
(43) Pub. Date: Jan. 7, 2016

(54) TUBE CONNECTOR

(71) Applicant: ORIDION MEDICAL 1987 LTD., Jerusalem (IL)

(72) Inventors: Mark Goldberg, Ashdod (IL); Joshua Lewis Colman, Jerusalem (IL)

(73) Assignee: ORIDION MEDICAL 1987 LTD., Jerusalem (IL)

(21) Appl. No.: 14/441,852

(22) PCT Filed: Feb. 27, 2014
(86) PCT No.: PCT/IL2014/050204

§ 371 Date: May 11, 2015

Related U.S. Application Data
(60) Provisional application No. 61/776,798, filed on Mar. 12, 2013.

(51) Int. Cl. G01N 21/21; G02B 5/30

(52) U.S. Cl. CPC G01N 21/21; G02B 5/3083

(57) ABSTRACT

Tube connector having at least one polarizing element arranged such that a tube connection system can identify at least one parameter of light passed through said first polarizing element, wherein said at least one parameter comprises presence of light, light polarization state, light polarization direction, light intensity or combinations thereof.

### TECHNICAL FIELD

This disclosure relates to the field of tube connectors used for connecting between a tube and a medical device, and to utilizing changes in polarization characteristics of light to identify the tube connector.

### BACKGROUND

Medical instruments often need to be temporarily connected to peripheral devices and components in the course of operation. An example may be a sampling tube connected to an analyzing instrument such as a capnograph. Another example may an ultrasound probe connected to a sonographic imaging instrument. Such peripheral devices may need to be replaced frequently due to one or more reasons. For example, a disposable probe may be used for each treated patient, and should be replaced after use by a new probe for a next patient. Another reason for frequently connecting and disconnecting probes from an instrument may be related to multi-purpose instruments. Such instruments are configured to carry our one of several routines, for obtaining one of several optional purposes. Generally, a particular routine and purpose may be associated with a specific peripheral device that needs to be connected to the instrument for carrying out the routine. Thus, frequent replacement of probes is required, typically being carried out by disconnecting a previously used probe and connecting a new probe to the instrument, instead.

### SUMMARY

The present disclosure relates to tube connecters including polarizing element(s) arranged such that a tube connection system can identify parameter(s) of light passed through the polarizing element(s).

The connectors of the present disclosure may for example be used in a respiratory gas sampling and/or delivery tubing systems. Such connectors are typically located at a distal end of a sampling line and are configured to connect a sampling tube to a fluid analyzer, such as a gas analyzer, for example a capnograph.

The connectors of the present disclosure include at least one polarizing element which enables identification of the connectors. Accurate identification of the connector may be of uttermost importance for ensuring correct connection between a medical device and its constituents such as tubes, probes etc. The constituents are often of the disposable type, are frequently replaced and may require abrupt connection for example in emergency situations. To avoid sometimes fatal misconnections as well as optimal functioning of the instrument, it can be necessary to ensure that the medical device is only activated when a correct tube is properly connected and authenticated.

According to certain aspects of the disclosure, the at least one polarizing element and the detection of the at least one parameter of the light passing therethrough may be utilized to ensure that a medical device is activated only when a correct plug is properly connected. This may prevent operation of a medical device when no constituent is connected or even when a correct constituent is improperly connected, thereby reducing damage to sensitive parts of the instrument as well as incorrect readings.

According to certain aspects of the disclosure, the parameters described herein may also serve to enable identification of the connector (and consequently the tube or other constituent attached thereto) as belonging to one of a number of classes. Such identification may enable the medical instrument to automatically operate as appropriate for the identified connector.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

According to some embodiments, there is provided a tube connector having at least one polarizing element (P1) arranged such that a tube connection system can identify at least one parameter of light passed through the first polarizing element.

According to some embodiments, the at least one parameter may include presence of light, light polarization state, light polarization direction, light intensity or combinations thereof.

According to some embodiments, the at least one parameter may be indicative of a preferred mode of operation of said tube connector.

According to some embodiments, the connection system is further configured to identify changes in the at least one parameter during insertion and/or revolving of the tube connector relative to a device connector.

According to some embodiments, the at least one polarizing element (P1) is positioned on an end face of the tube connecter. Alternatively or additionally, the at least one polarizing element (P1) is positioned on an outer wall of the tube connecter.

According to some embodiments, the at least one polarizing element (P1) is attached to, embedded in or molded on the tube connecter.

According to some embodiments, the at least one polarizing element (P1) is a waveplate. According to some embodiments, the waveplate is a half waveplate.

According to some embodiments, the at least one polarizing element (P1) comprises a linear polarizer. According to some embodiments, the linear polarizer is configured to transmit light parallel to a polarization axis of the linear polarizer and to block light perpendicular to the polarization axis.

According to some embodiments, the at least one linear polarizer includes a radially distributed polarizer.

According to some embodiments, the tube connecter further includes a reflective layer arranged such that said connection system can identify light passed through said first polarizing element and reflected by said reflective layer.

According to some embodiments, there is provided a method comprising forming a tube connector; and applying at least one polarizing element, in such way that a tube connection system can identify at least one parameter of light passing through the at least one polarizing element.

According to some embodiments, the method further includes applying a reflective layer between an end face of the tube connector and the at least one polarizing element.

According to some embodiments, applying includes attaching, molding, embedding or depositing said at least one polarizing element and/or said reflective layer on the tube connector.

According to some embodiments, the at least one polarizing element and/or the reflective layer is applied on an end face of said tube connector.

According to some embodiments, the at least one polarizing element and/or the reflective layer is applied on an outer wall of the tube connector.

According to some embodiments, there is provided a method for identifying connection of a tube connector to a device connector, the method including inserting a tube connector into a device connector; transmitting polarized light of a first polarization toward at least one polarizing element positioned on said tube connector; and detecting, using a light detector, at least one parameter of light having passed through the at least one polarizing element.

According to some embodiments, the method further includes activating the medical device when the at least one parameter is detected.

### BRIEF DESCRIPTION OF THE FIGURES

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1A schematically illustrates a perspective view of a connector having a polarizing element disposed on an end face thereof, according to some embodiments;

FIG. 1B schematically illustrates a perspective, exploded view of a connector having a polarizing element disposed on an end face thereof, according to some embodiments;

FIG. 1C schematically illustrates a perspective, exploded view of a connector having a polarizing element disposed on an end face thereof, according to some embodiments;

FIG. 2A schematically illustrate exemplary front views of polarizing elements, according to some embodiments;

FIG. 2B schematically illustrate exemplary front views of polarizing elements, according to some embodiments;

FIG. 2C schematically illustrate exemplary front views of polarizing elements, according to some embodiments;

FIG. 2D schematically illustrate exemplary front views of polarizing elements, according to some embodiments;

FIG. 2E schematically illustrate exemplary front views of polarizing elements, according to some embodiments;

FIG. 2F schematically illustrate exemplary front views of polarizing elements, according to some embodiments;

FIG. 2G schematically illustrate exemplary front views of polarizing elements, according to some embodiments;

FIG. 2H schematically illustrate exemplary front views of polarizing elements, according to some embodiments;

FIG. 3A schematically illustrates perspective views of connectors with polarizing elements disposed on an outer wall of the tube connectors, according to some embodiments;

FIG. 3B schematically illustrates perspective views of connectors with polarizing elements disposed on an outer wall of the tube connectors, according to some embodiments;

FIG. 4A schematically illustrates a perspective view of a connector having a polarizing element disposed on an end face thereof and a block diagram of a connection system, according to some embodiments;

FIG. 4B shows a flowchart illustrating the operation of the connection system of FIG. 4A;

FIG. 5A schematically illustrate a perspective view of a connector having a polarizing element disposed on an end face thereof and a block diagram of a connection system, according to some embodiments;

FIG. 5B shows a flowchart illustrating the operation of the connection system of FIG. 5A, wherein the polarizing element is a waveplate, according to some embodiments;

FIG. 5C shows a flowchart illustrating the operation of the connection system of FIG. 5A, wherein the polarizing element is a linear polarizer, according to some embodiments;

FIG. 6A schematically illustrate a perspective view of a connector having a polarizing element disposed on an end face thereof and a block diagram of a connection system, according to some embodiments;

FIG. 6B shows a flowchart illustrating the operation of the connection system of FIG. 6A, wherein the polarizing element is a linear polarizer, according to some embodiments;

FIG. 7A schematically illustrate a perspective view of a connector having a polarizing element disposed on an outer wall thereof and a block diagram of a connection system, according to some embodiments;

FIG. 7B shows a flowchart illustrating the operation of the connection system of FIG. 7A, according to some embodiments;

FIG. 8A schematically illustrate a perspective view of a connector having a polarizing element disposed on an outer wall thereof and a block diagram of a connection system, according to some embodiments;

FIG. 8B shows a flowchart illustrating the operation of the connection system of FIG. 8A, according to some embodiments;

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

There is provided herein, according to some embodiments, a tube connector including a polarization element, a device configured to identify the tube connector, a system including the device and the tube connector as well as methods of identification of the tube connector utilizing polarization characteristics of light passed through the polarizing element.

As used herein, the term “tube connector” may refer to a connector configured to connect between a tube, such as for example a sampling tube and a medical device (for example a gas analyzer). Alternatively or additionally, the connector can also be used for connecting any other element such as, but not limited to, cannules, pulse oxymeter probes, Electrocardiography (ECG) or Electroencephalography (EEG) probes, non-invasive blood pressure (NIBP) Cuffs and the like, to a medical device. The tube connector may be a radial connector, for instance a luer connector, such as a female and/or male luer connector. However other connectors, such as non-radial push-in connectors also fall within the scope of the present disclosure.

As used herein, the term “device connector” may refer to a connector configured to receive a tube connector.

As used herein, the term “identification region” of the connector may refer to the region of the connector utilized for identification (and/or authentication) of the connector. As used herein the identification region may be located on the end face of the connector, on an outer wall of the connector or a combination thereof.

As used herein, the term “end face” of the connector may refer to the part of the connector which is configured to connect to the device.

As used herein, the term “polarization element” may refer to an element configured to change the polarization characteristics of light, such as the polarization state and/or direction of incident light.

As used herein, the term “at least one” may refer to 1, 2, 3, 4, 5 or more. Each possibility is a separate embodiment. For example, at least one polarizing element may refer to, one, two, three, four, five or more polarizing elements. Each possibility is a separate embodiment.

As used herein, the term “polarization state” may refer, for example, to non-polarized light, linearly polarized light, circularly polarized light and elliptically polarized light.

As used herein, the term “polarization direction” may refer to the orientation of the electromagnetic fields of the light at a point in space over one period of oscillation or to the polarization plane of the light.

As used herein the terms “incident light” and “incoming light” may be interchangeably used and may refer to light emitted from a light source. In certain embodiments incident light refers to light emitted from a light source and polarized by a polarizing element placed in proximity to the light source.

As used herein the terms “reflective layer” and “reflective surface” may be interchangeably used and may refer to a surface/layer which reflect light. The reflectivity may for example be obtained by coating a surface with a reflective material (such as Foil SLNM, available from Kurz Ltd, Germany), or by polishing the surface to a glossy finish. The reflected layer can be positioned on the end surface of the tube connector or on the polarizing element (on the tube connector side) as described in some embodiments. According to some embodiments, the reflective layer need not to extend over the entire end face/polarizing element, nor does it need to close an annular ring.

As used herein, the terms “waveplate” and “retarder” may be interchangeably used and may refer to an optical device that alters the polarization direction and/or polarization state of light travelling through it. Common types of waveplates are the half-waveplate, which shifts the polarization direction of linearly polarized light, and the quarter-waveplate, which converts linearly polarized light into circularly polarized light and vice versa.

As used herein, the term “polarizer” may refer to an optical filter that passes light of a specific polarization and blocks waves of other polarizations. Common types of polarizers include for example, linear polarizers and circular polarizers.

As used herein, the term “linear polarizer” may refer to an optical filter configured to pass light parallel to the polarization axis of the filter and to absorb light perpendicular to the polarization axis.

As used herein, the term “polarization axis” may refer to the plane of polarization of the polarizing element.

As used herein, the term “connection system” may refer to may refer to a system configured to identify a proper connection of a tube connector to a device connector. According to some embodiments, proper connection is identified when a correct tube connector reaches a final position indicating that the tube connector is entirely inserted into the device connector. According to some embodiments, the medical device is actuated when the connector reaches its final position in the device connector. Additionally or alternatively, according to some embodiments, proper connection is identified when a correct tube connector reaches an intermediate position indicating that the tube connector is partially but sufficiently inserted into the device connector. It is understood by one of ordinary skill in the art that sufficient connection may refer to a connection in which the tube connector is inserted adequately enough into the device connector to avoid leaks and misreadings, but does not necessarily require that the tube connector reaches its final connection position. According to some embodiments, the medical device is actuated when the tube connector reaches such intermediate and sufficient connection.

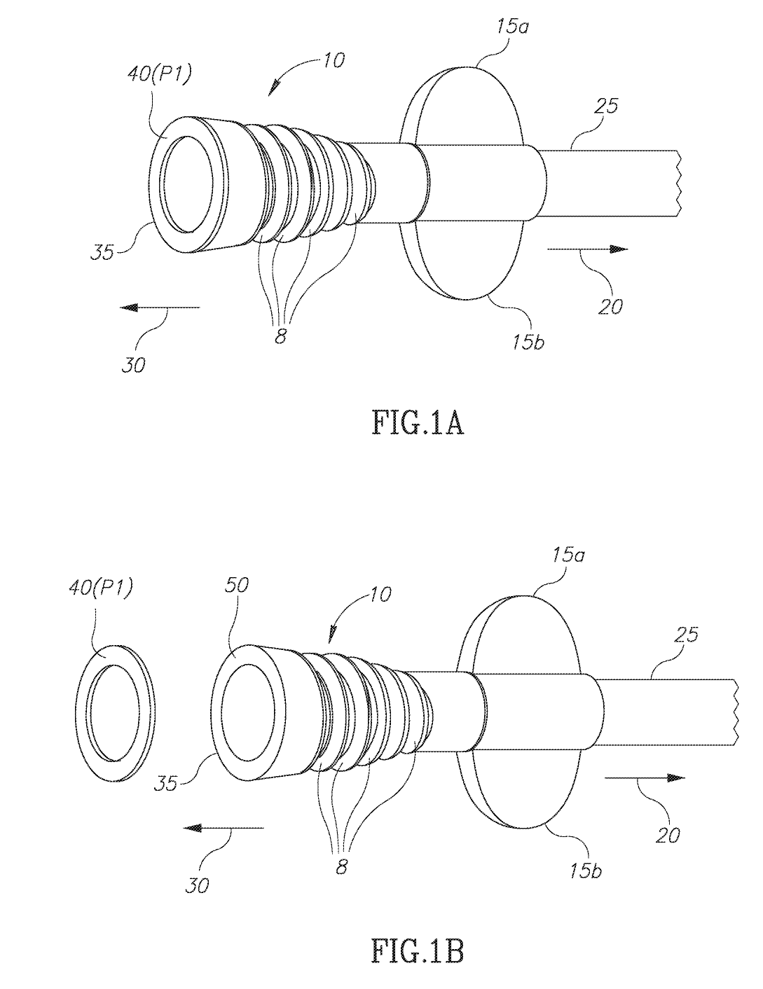

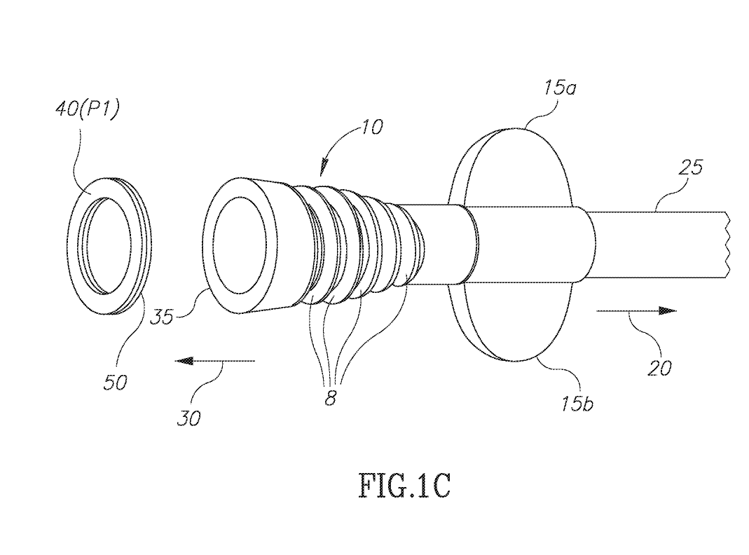

Reference is now made to FIGS. 1A-C, which schematically illustrate perspective views of a connector having a polarizing element disposed on an end face thereof, according to some embodiments. The connecter, such as connector 10, may include two ends: a tube end 20, which is the end that may be connected to a tube 25 (such as a breath sampling tube); and a device end 30, which is the end that may be used to connect the connector to a device/instrument, such as but not limited to, a capnograph (not shown).

Connector 10 may be a male or a female type connector that may be received by or be connected/attached to a matching female or male connector (referred to herein as a “device connector”), respectively, located on the device panel. Connector 10 may have an elongated cylindrical-like shape. Spiral threads, such as threads 8, may be found at the outer surface of the connector in close proximity to device end 30 of connector 10 and may be used to secure connector 10 to its matching connector on the device (the device connector). At the tube end 20 of connector 10, gripping wings, (such as, gripping wings 15a-b) are located. Tube connector 10, includes a polarizing element (P1) 40 and a reflective layer 50. Reflective layer 50 is attached to, deposited on, embedded in or molded directly on end face 35 (as illustrated in FIG. 1B), or on polarizing element 40 (as illustrated in FIG. 1C) and then subsequently to end face 35. Hence, polarizing element (P1) 40 may be attached to, deposited on, bonded to or molded directly on end face 35 (as illustrated in FIG. 1A) or, according to an alternative embodiment, externally to reflective layer 50 (as illustrated in FIGS. 1B and C). According to this embodiment, reflective layer 50 will be positioned between end face 35 and polarizing element 40 (P1)) in such manner that incident light passing through polarizing element (P1) 40 is reflected by reflective layer 50 and subsequently passed back through polarizing element (P1) 40.

According to some embodiments, incident light passing through polarizing element (P1) 40 is linearly polarized light. Alternatively, incident light passing through polarizing element (P1) 40 is unpolarized light. Alternatively, incident light passing through polarizing element (P1) 40 is circularly or elliptically polarized light.

According to some embodiments, incident light passing through polarizing element 40 may be of different wavelengths such as for example Near Infra-Red (NIR) light with wavelength in the range of 800-2500 nm, UV light with wavelengths of 365-395 or visible (VIS)-NIR light with wavelength in the range of 560-1000.

According some embodiment, polarizing element (P1) 40 may be a waveplate. According to some embodiments the waveplate is a half waveplate. A half waveplate is configured to shifts the polarization direction of linearly polarized light. For linearly polarized light, the effect of the half-wave plate is to rotate the polarization vector by an angle of 2θ relative to the polarization direction of the incident polarized light. According to some embodiment, linearly polarized light pass through the half waveplate twice, due to the reflection by the reflective layer. In effect the polarization vector will be rotated and exit the waveplate as linearly polarized light with an angle of 4θ relative to the polarization direction of the incident polarized light.

According to some embodiments, the waveplate is a quarter waveplate. A quarter waveplate is configured to convert linearly polarized light into circularly polarized light and vice versa. According to some embodiment, linearly polarized light pass through the quarter waveplate twice, due to the reflection by the reflective layer. In effect, the circularly polarized light will exit back through the quarter wave plate as linearly polarized light rotated by an angle of 2θ relative to the polarization direction of the incident polarized light.

According to some embodiments the wave plate can be a multiple-order waveplate, a zero-order wave plate or an achromatic waveplate. Each possibility is a separate embodiment.

According to some embodiments, the waveplate can be made of a material selected from the group consisting of: crystalline quartz, calcite, magnesium fluoride, sapphire, mica, birefringent polymers and combination thereof. Each possibility is a separate embodiment. One skilled in the art will realize that other suitable materials can be utilized as well and fall within the scope of the present disclosure.

According to some embodiment incident light exits the waveplate with approximately/essentially the same intensity as that of the incident linearly polarized light. As used herein, the terms “approximately same intensity” and “essentially the same intensity” interchangeably refer to an intensity of exit light deviating from incident light intensity by about 0-3% by about 0-5% by about 5-10%.

According some embodiment, polarizing element (P1) 40 may be a linear polarizer. A linear polarizer is configured to transmit light parallel to a polarization axis of the linear polarizer and to block light perpendicular to the polarization axis. Light will exit the polarizer with only the component parallel to the polarization axis of the polarizer. The intensity of light exiting the polarizer depends on the polarization angle of incident light relative to the polarization angle of the polarizer as described in Malus' Law: Iₒᵤₜ=Iᵢₙ*cos² θ wherein θ is the angle between the polarization direction of the incident light and the polarization axis of the polarizer. For example unpolarized light will exit the polarizer with about half the intensity of the incident light. For example linearly polarized light with a polarization direction parallel to the polarization axis of the polarizer will exit with about the same intensity as that of the incident light. For example linearly polarized with a polarization direction perpendicular to the polarization axis of the polarizer will essentially be absorbed by the polarizer.

As used herein the term “essentially absorbed” refers to less than 10% of the incident light exiting the polarizer, less than 5% of the light exiting the polarizer, less than 1% of the light exiting the polarizer. Each possibility is a separate embodiment.

As used herein the term “about” refers to +/−10%.

According to some embodiments, the linear polarizer is an absorptive polarizer selected from the group consisting of: a polymer sheet polarizer, a polarizing glass, a glass polarizer or any combination thereof. Each possibility is a separate embodiment.

According to some embodiments, the linear polarizer is adapted to linearize Near Infra-Red (NIR) light with wavelength in the range of 800-2500 nm, UV light with wavelengths of 365-395 or visible (VIS)-NIR light with wavelength in the range of 560-1000.

According to some embodiments the tube connector is a radial connector rotated into a mating device connector for proper connection. Alternatively, the tube connector is a non-radial connector pushed into its mating device connector for proper connection.

According to some embodiments, the angle between the polarization direction of incident light and the polarization axis of polarizing element (P1) 40 may be utilized in the identification and classification of tube connector 10.

According to some embodiments, the angle between the polarization direction of incident light and the polarization axis of polarizing element (P1) 40 is constant such as for example when tube connector 10 is a non-radial push-in connector. Alternatively the angle between the polarization direction of incident light and the polarization axis of polarizing element (P1) 40 may be dynamic and dependent on the position of tube connector 10 relative to a device connector such as for example when tube connector 10 is a radial connector rotated during connection to a device connector.

According to some embodiments, the angle between the polarization direction of incident light and the polarization axis of polarizing element (P1) 40 may be between 0-90 degrees relative to each other. Each possibility is a separate embodiment.

As a non-limiting example, a push-in tube connector used to connect a sampling tube for neonatals sampling can have a polarization element positioned such that an angle of 30 degrees is generated between the polarization direction of incident light and the polarization axis of polarizing element (P1) 40 whereas a connector connected to a tube used for the same purpose in adults has a different polarization angle. For example, a tube used for one purpose can have a connector with a polarizing element positioned in a way that a certain angle is generated relative to incoming light whereas another tube used for a different purpose (yet may be mistakenly attached to the same connector panel) generates a different polarization angle.

According to some embodiment, in cases of radial screw-in connectors, the first polarizing element may be positioned on an identification region located on the end face of the connector. In effect, the light intensity detected by a light detector at any time during rotation (screwing) of the connector into the device depends on the relative position of the polarization axis at that given moment. It is further understood by the skilled in the art that rotation of the tube connector relative to device connector, will cause incremental sinusoidal decreases/increases in the light intensity detected by the light detector. Such incremental changes can serve as an identification characteristic.

Alternatively, polarization element can be radially distributed on the annular identification region, such that the relative position of the polarization axis of the first polarizing element is constant during rotation (screwing).

Alternatively, the first polarizing element can be annularly distributed on the side of the connector, as described herein below. Such positioning likewise facilitates that the relative position of the polarization axis of the first polarizing element is constant during rotation.

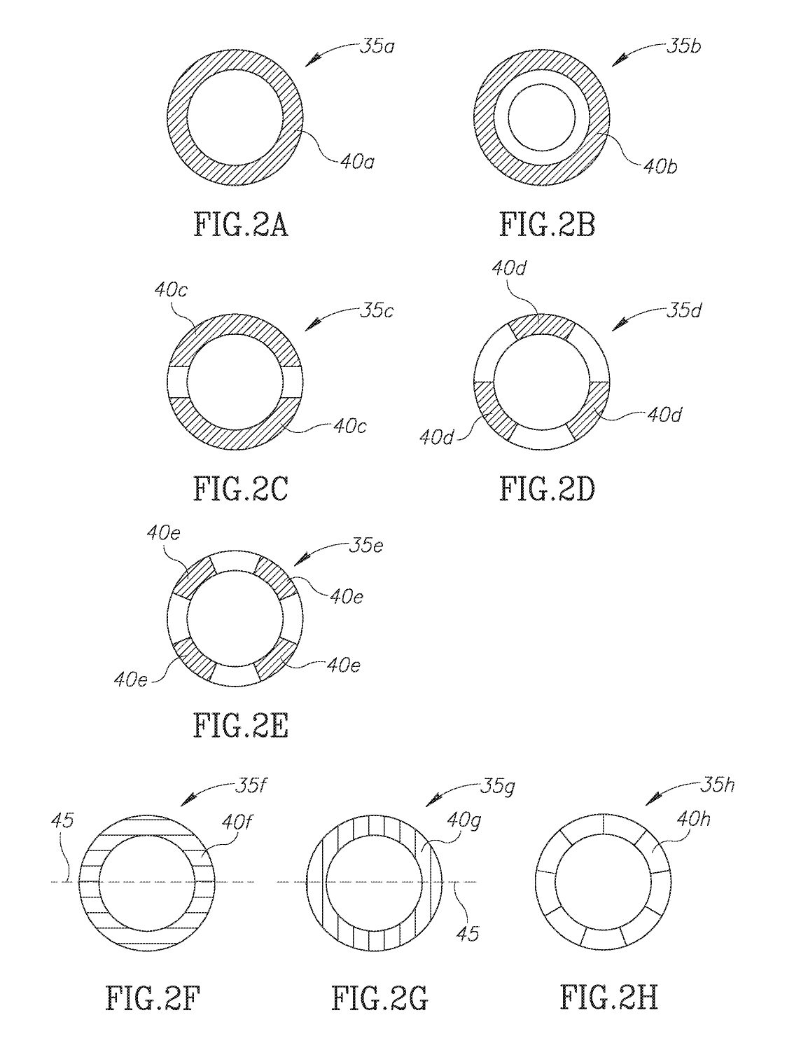

Reference is now made to FIGS. 2A-H, which schematically illustrate exemplary front views of polarizing elements, according to some embodiments. Polarizing elements, generally referred to as polarizing elements 40 may be disposed on an identification region on the end face of a tube connector. FIGS. 2A-2E illustrate non-limiting examples of optional distributions of polarizing element (P1) 40a-40e, on end face 35 of tube connector 10. According to some embodiments, the distribution of first polarizing element (P1) 40 on end face 35 is different for different classes of tube connectors.

According to some embodiments polarizing element 40a occupies the entire annular circumference of end face 35 (FIG. 2A). According to other embodiments polarizing element 40b is a continuous ring which occupies part of the annular circumference of end face 35 (FIG. 2B). According to other embodiments polarizing element 40 is a discontinuous ring dividing polarizing element 40c into two regions at the annular circumference of end face 35 (FIG. 2C). According to other embodiments polarizing element 40d is a discontinuous ring dividing polarizing element 40d into three regions at the annular circumference of end face 35 (FIG. 2D). According to other embodiments polarizing element 40e is a discontinuous ring dividing polarizing element 40e into four regions at the annular circumference of end face 35 (FIG. 2E). It is understood by the skilled in the art that other distributions of polarizing element 40e on end face 35 all fall within the scope of the disclosure. FIGS. 2F-2H illustrates the polarization axis of polarizing elements 40f-h. According to some embodiment the polarization axis of polarizing element 40f is parallel to the axis of gripping wings (15a-b in FIG. 1), illustrated by a horizontal line 45 (FIG. 2F). According to some embodiment the polarization axis of polarizing element 40g is perpendicular to horizontal line 45 (FIG. 2G). According to some embodiment the polarization axis of polarizing element 40h is radially distributed (FIG. 2H). According to some embodiments, the distribution of first polarizing element 40 on end face 35 is different for different classes of tube connectors. As a non-limiting example, a tube connector used to connect a sampling tube for neonatal sampling can have a polarization element positioned as described in FIG. 2C whereas a connector connected to a tube used for the same purpose in adults has a polarization element positioned as described in FIG. 2D.

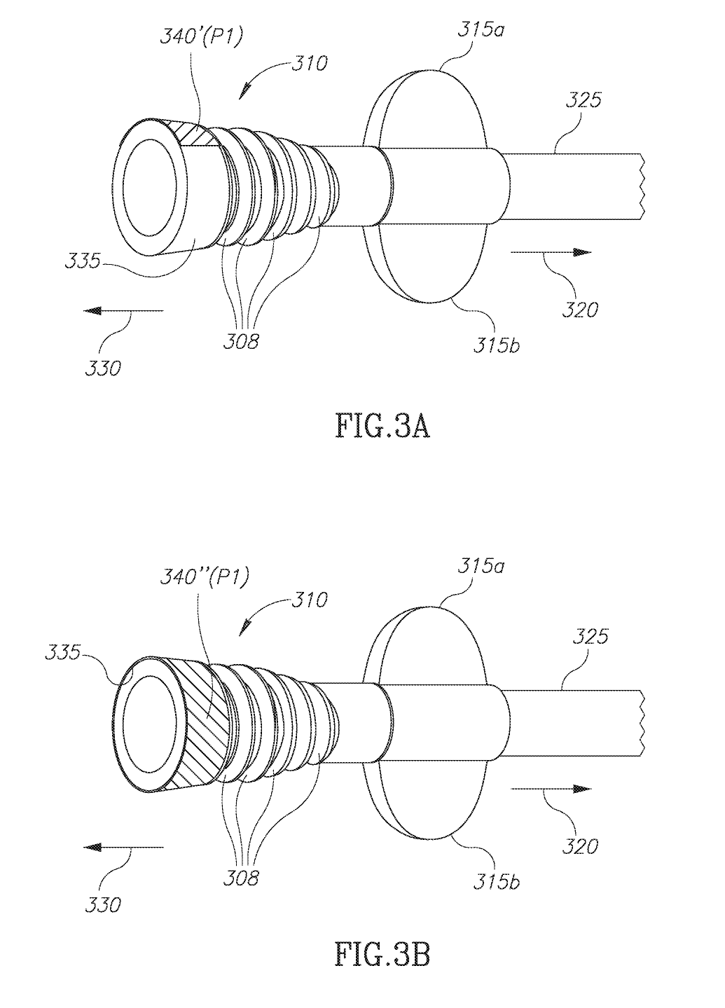

Reference is now made to FIGS. 3A-B, which schematically illustrate perspective views of connectors with polarizing elements disposed on an outer wall of the tube connectors, according to some embodiments. The connecter, such as connector 310, may include two ends: a tube end 320, which is the end that may be connected to a tube 325; and a device end 330, which is the end that may be used to connect the connector to a device/instrument (not shown).

Connector 310 may be a male or a female type connector that may be received/connected/attached/to a matching female or male connector (referred to herein as a “device connector”), respectively, located on the device, such as, for example, on the device panel. Connector 310 may have an elongated cylindrical-like shape. Spiral threads, such as threads 308, may be found at the outer surface of the connector in close proximity to the device end 330 of connector 310 and may be used to secure connector 310 to its matching connector on the device (the device connector). At the tube end 320 of connector 310, gripping wings, (such as, gripping wings 315A-B in FIG. 3) are located. According to some embodiments; tube connector 310 is made of transparent plastic. According to some embodiments, the tube connector 310 is made of a material which facilitates transmission of light without changing its polarization state. According to some embodiments, the tube connector 310 is made of a material which facilitates transmission of light while changing its polarization state.

Connector 310 further includes a polarizing element (P1) 340, attached to, deposited on, bonded to or molded on outer wall 335. Polarizing element 340 can be positioned on a part of outer wall 335 (for example illustrated as 340′ in FIG. 3A) or can form an annular ring on outer wall 335 (illustrated as 340″ in FIG. 3B). Alternatively polarizing elements can be positioned on more than one region of outer wall 335.

According to some embodiments, incident light passing through polarizing element 340 is linearly polarized light. Alternatively, incident light passing through polarizing element 340 is unpolarized light. Alternatively, incident light passing through polarizing element 340 is circularly or elliptically polarized light.

According to some embodiments, incident light passing through polarizing element 340 may be of different wavelengths such as for example Near Infra-Red (NIR) light with wavelength in the range of 800-2500 nm, UV light with wavelengths of 365-395 or visible (VIS)-NIR light with wavelength in the range of 560-1000.

According some embodiment, polarizing element 340 may be a waveplate. According to some embodiments the waveplate is a half waveplate. A half waveplate is configured to shifts the polarization direction of linearly polarized light. For linearly polarized light, the effect of the half-wave plate is to rotate the polarization vector by an angle of 2θ relative to the polarization direction of the incident polarized light.

According to some embodiment incident light exits the waveplate with approximately/essentially the same intensity as that of the incident linearly polarized light. As used herein, the terms “approximately same intensity” and “essentially the same intensity” interchangeably refer to an intensity of exit light deviating from incident light intensity by about 0-3% by about 0-5% by about 5-10%.

According some embodiment, polarizing element 340 may be a linear polarizer. A linear polarizer is configured to transmit light parallel to a polarization axis of the linear polarizer and to block light perpendicular to the polarization axis. Light will exit the polarizer with only the component parallel to the polarization axis of the polarizer. The intensity of light exiting the polarizer depends on the polarization angle of incident light relative to the polarization angle of the polarizer as described in Malus' Law: Iₒᵤₜ=Iᵢₙ*cos² θ wherein θ is the angle between the polarization direction of the incident light and the polarization axis of the polarizer. For example unpolarized light will exit the polarizer with about half the intensity of the incident light. For example linearly polarized light with a polarization direction parallel to the polarization axis of the polarizer will exit with about the same intensity as that of the incident light. For example linearly polarized with a polarization direction perpendicular to the polarization axis of the polarizer will essentially be absorbed by the polarizer.

As used herein the term “essentially absorbed” refers to less than 10% of the incident light exiting the polarizer, less than 5% of the light exiting the polarizer, less than 1% of the light exiting the polarizer. Each possibility is a separate embodiment.

As used herein the term “about” refers to +/−10%.

According to some embodiments, the angle between the polarization direction of incident light and the polarization axis of polarizing element 340 may be utilized in the identification and classification of connector 310.

According to some embodiments, the angle between the polarization direction of incident light and the polarization axis of polarizing element 340 may be between 0-90 degrees relative to each other. Each possibility is a separate embodiment.

According to some embodiments, there is provided a medical device. According to some embodiments the medical device is a fluid analyzer. According to some embodiments the medical device is a capnograph.

According to some embodiments, the medical device includes a device connector configured to receive a tube connector such as tube connector 10 and connector 310 of FIGS. 1 and 3, respectively, and a connection system configured to identify and or classify the tube connector (and hence the tube) attached to the medical device. For example, the connection system of the medical device may detect the intensity of the light reaching the connection system after having passed through a polaring element positioned on the connector. The connection system may include one or more optical light source emitters such as, for example, Light Emitting Diodes (LEDs) that may emit light at various individual wavelengths and/or at a wide spectral range of wavelengths. For example, the light source may include a Light Emitting Diode (LED) that may emit light at the visible white light spectral range (for example, at the range of 0.4 to 0.7 mm) Alternatively the light source can be a lamp, a laser diode or other suitable light sources.

The connection system may further include one or more light detectors configured to detect the intensity of light having passed through the polarizing element of the connector. The light detectors may be spatially separated from the light source emitters so as to ensure that light detected by the optical receivers is the light emitted from the connector. Spatial separation may be performed, for example by placing an optical barrier between the light source and the optical receiver. The spatial separation may be performed, for example, by use of optical wave guides that may be used to create a channel/chamber, at the bottom of which the optical detector is situated. The use of such a chamber may ensure that only light that is transmitted from the connector reaches the optical receiver, while light, such as scattered light from the environment, direct light from the light source, and the like, is prevented from reaching the optical detector. The light transmitted from the connector may be of various intensities, which may be determined by the properties and the positioning of the polarizing element on connector as described hereinabove.

According to some embodiments, the connection system includes a polarizing element (P2) attached to or in close proximity to the light detector. According to some embodiments, the polarizing element (P2) has a polarization axis perpendicular to that of the incident light. In effect, linearly polarized light transmitted from (for example reflected from) a connector devoid of a polarizing element will reach the light detector with a polarization angle perpendicular to the polarization axis of polarizing element (P2) of the connection system and will therefore be essentially absorbed.

According to some embodiments, the angle between the polarization axis of the second polarizing element (P2) relative to the polarization axis of first polarizing element (P1) 340 is constant such as for example when tube connector 310 is a non-radial push-in connector. For example the angle between the polarization axis of the second polarizing element (P2) and the polarization axis of first polarizing element (P1) 340 may be between 0-90 degrees. Alternatively angle between the polarization axis of the second polarizing element (P2) relative to the polarization axis of first polarizing element (P1) 340 may be dynamic and dependent on the position of tube connector 310 relative to a device connector.

According to some embodiments, the connection system includes a processor configured to identify the tube connector type based on the signal received from the one or more light detectors. For example, the connection system may be used to analyze the properties and characteristics of the connector attached to the medical device, and accordingly change the mode of operation of the device. For example, in relation to detection of light transmitted from the connector, the medical device may include the various electrical circuits that may further include various constituents for generating and processing optical signals transmitted to the connector and received therefrom and based upon the analyzed results determine if the connector is properly connected to the medical device and identify what is the type, class, model and/or interface of the connector (and hence the tube attached thereto).

Yet another purpose which may be served by the connection system is to optimize the performance of the device according to a parameter, such as resistance, unique to a specific patient interface. This is often done, when it is more economical to make the consumable part as simple as possible with large tolerances, but adding an indication to the device to correct for this tolerance.

The following examples illustrate embodiments of a tube connector and a medical device including a connection system configured to identify, authenticate, and/or specify, the tube connector. It is understood by the skilled in the art that these examples are meant to be non-limiting and that additional combinations of the disclosed elements likewise fall within the scope of the present disclosure,

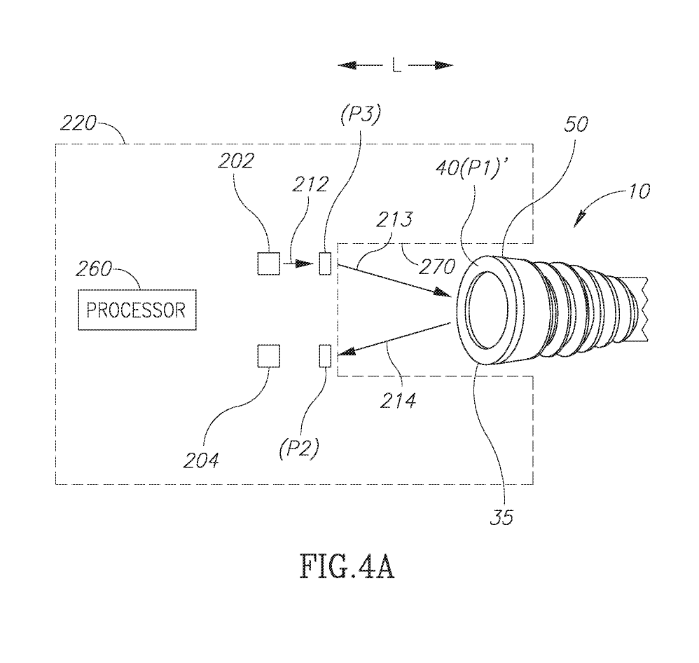

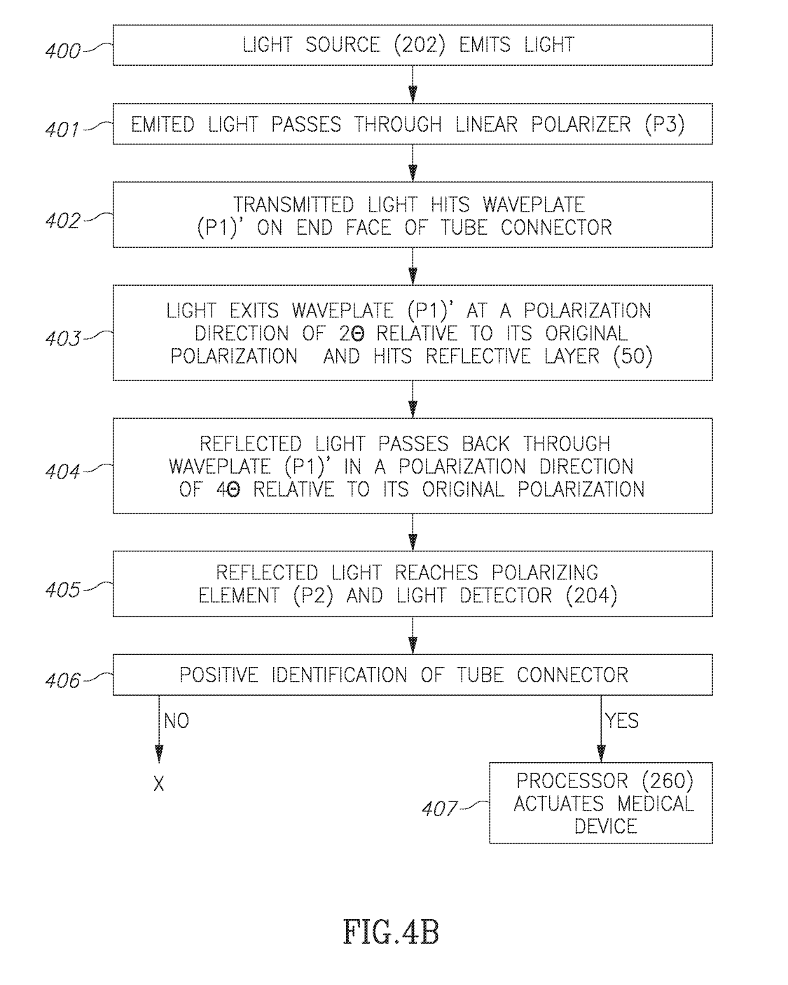

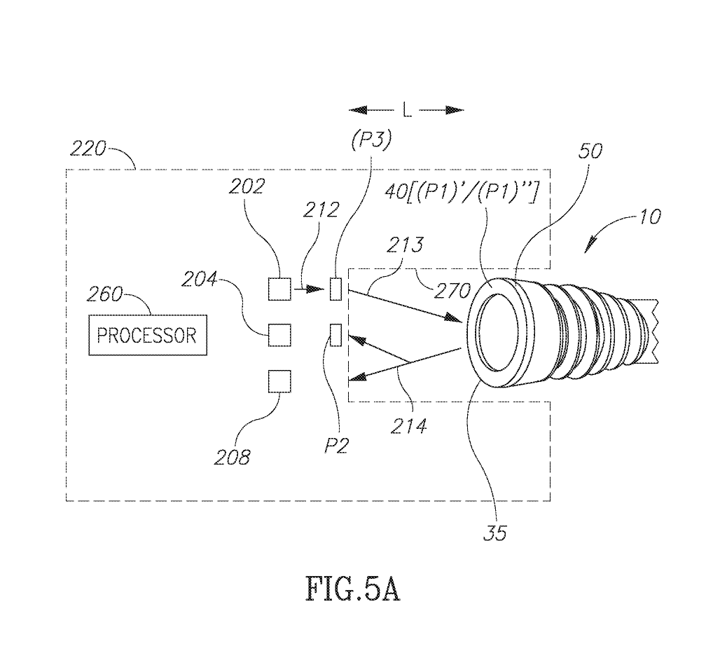

Reference is now made to FIG. 4A, which schematically illustrates a perspective view of a connector having a polarizing element disposed on an end face thereof and a block diagram of a connection system, according to some embodiments.

As essentially described hereinabove, tube connector 10, includes an end face 35. End face 35 includes a first polarizing element generally referred to as (P1), (for example, a half waveplate (P1)′ as shown herein or a linear polarizer), and a reflective layer (not shown). According to some embodiments, (P1) may be similar to polarizing element 40, shown in FIGS. 1-2. Connection system 220 of a medical device (such as a gas analyzer, for example, a capnograph) is configured to identify, authenticate, and/or specify a tube connector, according to some embodiments. Connection system 220 includes a device connector 270, and one or more light sources (shown as one light source 202) such as for example a LED, a lamp or a laser. Connection system 220 further includes one or more light detectors (shown as one light detector 204) and a polarization element such as for example linear polarizer (P2). Linear polarizer (P2) is, according to some embodiments, configured to change the polarization direction of light reflected from end face 35 of tube connector 10.

Optionally, connection system 220 further includes an additional polarizing element such as for example a linear polarizer (P3) configured to convert unpolarized light from light source 202 to linearly polarized light with a polarization direction of θ. Alternatively, light source 202 may be configured to emit linearly polarized light, such as for example a laser diode, with a polarization direction of θ (option not shown).

Reference is now made to FIG. 4B, which shows a flowchart illustrating the operation of the connection system of FIG. 4A. In operation, in step 400 light source 202 of connection system 220 emits light towards end face 35 of tube connector 10 (illustrated by arrow 212 in FIG. 4A). In step 401, the emitted light optionally passes through linear polarizer (P3) thereby being converted to linearly polarized light with a polarization direction of θ (illustrated by arrow 213 in FIG. 4A). In step 402, the light hits half waveplate (P1)′ located on end face 35 of tube connector 10. In step 403, light exits half wave plate (P1)′ with a polarization direction of 2θ with respects to its original polarization and hits reflective layer 50. In step 404, reflected light passes back through half waveplate (P1)′ in a polarization direction of 4θ relative to its original polarization (illustrated by arrow 214 in FIG. 4A). In step 405, reflected light reaches linear polarizer (P2) and light detector 204. Processor 260 receives (from light detector 204) a signal indicative of the light intensity and determines, based on the signal received, whether or not tube connector 10 is positively identified (step 406). In case of positive identification of tube connector 10, processor 260 actuates the medical device and optionally determines the operation mode of the device (step 407). If positive identification of tube connector 10 is not determined in step 406, the medical device is not actuated.

According to some embodiments, linear polarizer (P2) has a polarization axis which is perpendicular to the polarization axis of linear polarizer (P3). Accordingly, if for example linearly polarized light hits half waveplate (P1)′ with a polarization angle of 22.5 degrees relative to the polarization axis of half waveplate (P1)′ it exists the half waveplate with a rotation of 90 degrees and will therefore be aligned with the polarization axis of linear polarizer (P2) and pass through linear polarizer (P2) essentially without loss in light intensity. In effect the light intensity hitting light detector 204 is essentially only dependent on the distance L between end face 35 and light detector 204.

Alternatively, if for example linearly polarized light hits half waveplate (P1)′ with a polarization angle of 11.25 degrees relative to the polarization axis of the half waveplate it exits half waveplate (P1)′ with a rotation of 45 degrees. Since only the fraction of light perpendicular to the polarization axis of linear polarizer (P2) will pass through linear polarizer (P2) it will exit linear polarizer (P2) with essentially half its intensity. In accordance, it is understood by the skilled in the art, that the light intensity hitting light detector 204 is dependent on the angle between the polarization axis of incident light and of half waveplate (P1)′, the angle between the polarization axis of reflected light and the polarization axis of linear polarizer (P2) as well as the distance L between end face 35 and light detector 204. According to this embodiment, any angle of 0-90 degrees between the polarization direction of incident light and the polarization axis of half wave plate (P1)′ on end face 35 will result in a light intensity detected by light detector 204 which is greater than that detected when a tube connector with a reflective layer but devoid a wave plate is used. In accordance the detection of a light with an intensity above a predetermined threshold can serve as a signal to a processer 260 part of connection system 220 to activate the medical device.

According to some embodiments, connector 10 is a radial connector. In accordance, it is understood by the skilled in the art that rotation of tube connector 10 relative to device connector 270 results in a rotation of the polarization axis of polarizing element 40 such as half wave plate (P1)′ relative to linear polarizer (P3) and linear polarizer (P2). In effect, the light intensity detected by light detector 204 at any time during rotation depends on the relative position of the polarization axis of half waveplate (P1)′ at that given moment. It is further understood by the skilled in the art that rotation of tube connector 10 relative to device connector 270, will cause incremental sinusoidal decreases/increases in the light intensity detected by light detector 204. According to some embodiments, connection system 220 is configured to identify tube connector 10 during its attachment to medical device connector 270 by identifying the recurring changes in the light intensity during rotation of tube connector 10 relative to device connector 270.

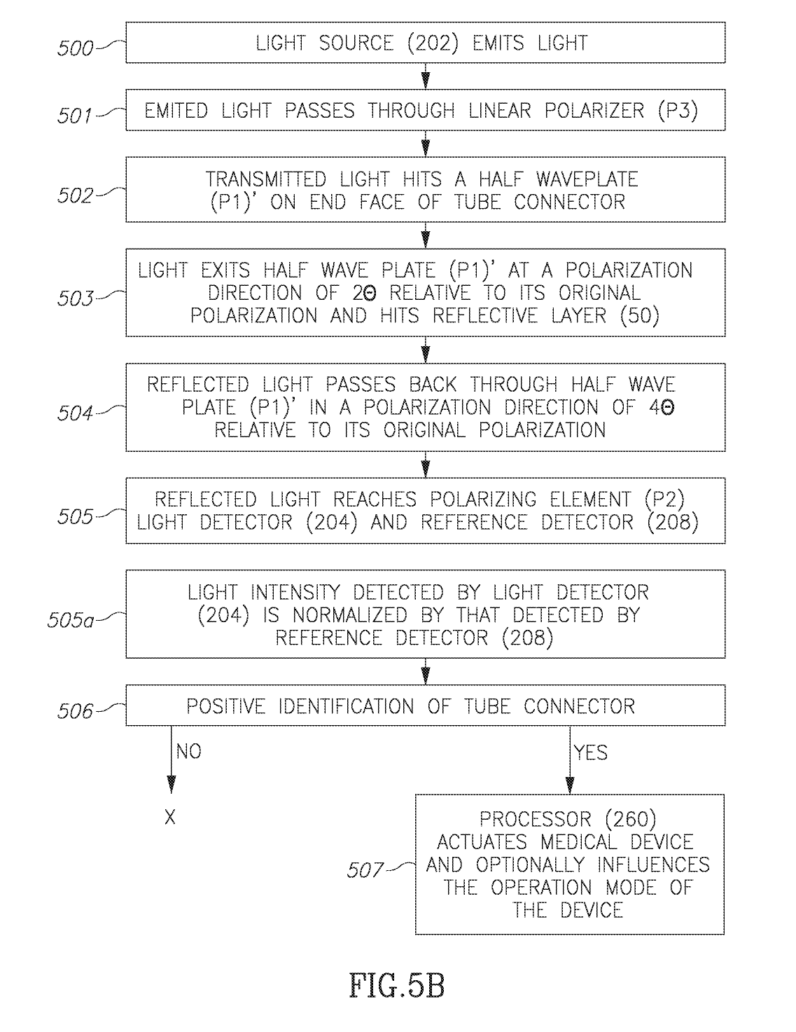

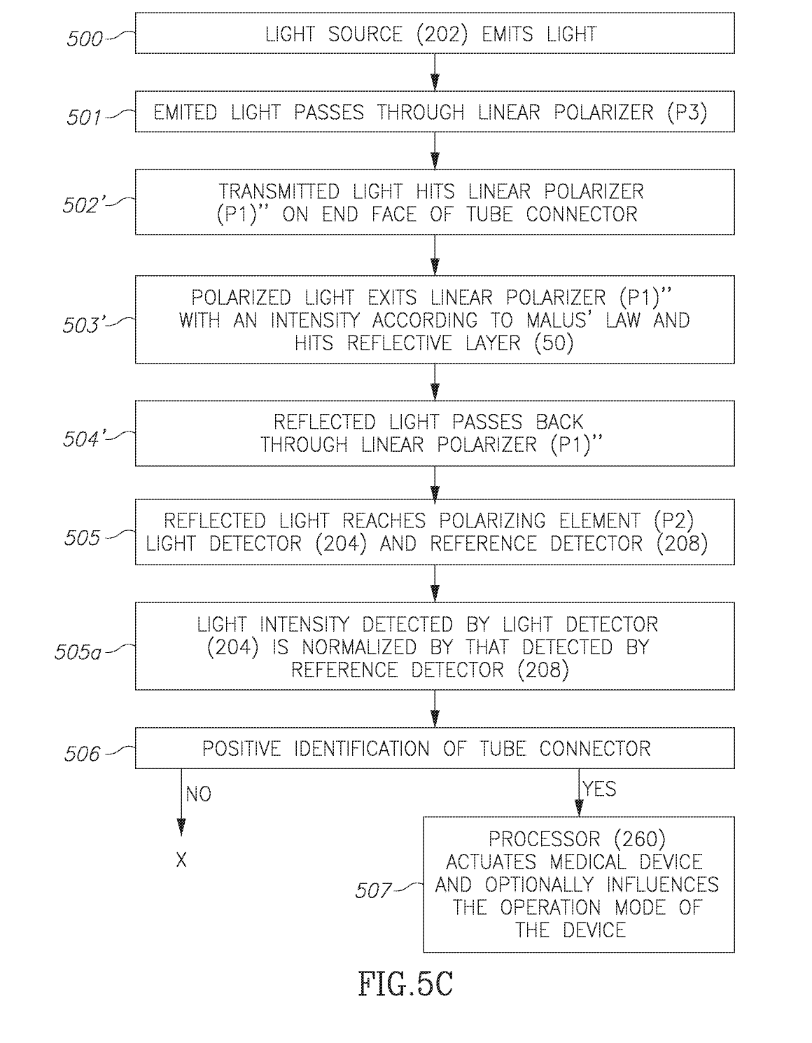

Reference is now made to FIG. 5A, which schematically illustrate a perspective view of a connector having a polarizing element disposed on an end face thereof and a block diagram of a connection system, according to some embodiments. As essentially described hereinabove, tube connector 10, includes an end face 35 on an end face thereof. End face 35 includes a first polarizing element generally referred to as (P1), (for example, a half waveplate (P1)′ or a linear polarizer (P1)″ as shown herein), and a reflective layer (not shown). According to some embodiments, (P1) may be similar to polarizing element 40 as shown in FIGS. 1-2. Connection system 220 of a medical device (such as a gas analyzer, for example, a capnograph) is configured to identify, authenticate, and/or specify a tube connector, according to some embodiments. Connection system 220 includes a device connector 270, one or more light sources 202; one or more light detectors 204; a polarization element, such as for example linear polarizer (P2) configured to change the polarization direction of light reflected from an end face 35 of tube connector 10; and optionally an additional polarizing element such as linear polarizer (P3) configured to linearly polarize light emitted from light source 202. As shown in FIG. 5A, connection system 220 further includes one or more reference detectors (shown as one reference detector 208).

Reference is now made to FIG. 5B, which shows a flowchart illustrating the operation of the connection system of FIG. 5A, wherein the polarizing element is a half waveplate (P1)′, according to some embodiments.

In operation, in step 500 light source 202 of connection system 220 may emit light towards end face 35 of tube connector 10 (illustrated by arrow 212 in FIG. 5A). In step 501, the emitted light optionally passes through linear polarizer (P3) thereby being converted to linearly polarized light with a polarization direction of θ (illustrated by arrow 213 in FIG. 5A). In step 502, the light hits half wave plate (P1)′, placed on end face 35 of tube connector 10. In step 503, light exits half waveplate (P1)′ with a polarization direction of 2θ with respects to its original polarization, and hits reflective layer 50. In step 504, reflected light passes back through half waveplate (P1)′ and exits in a polarization direction of 4θ relative to its original polarization (illustrated by arrow 214 in FIG. 5A). In step 505, reflected light reaches linear polarizer (P2), light detector 204 and reference light detector 208. In step 505a, the light intensity detected by light detector 204 is normalized to that detected by reference light detector 208. Processor 260 receives (from light detector 204) a signal indicative of the light intensity and determines, based on the signal received, whether or not tube connector 10 is positively identified (step 506). In case of positive identification of tube connector 10, processor 260 actuates the medical device and optionally determines the operation mode of the device (step 507). If positive identification of tube connector 10 is not determined in step 506, the medical device is not actuated.

According to this embodiment, the dependence of the light intensity detected by light detector 204 on distance L between end face 35 and light detector 204 can be excluded by normalizing the light intensity obtained by light detector 204 to that obtained by reference light detector 208. In accordance, the normalized light intensity detected by light detector 204 is only dependent on the angle between the polarization direction of incident light relative to the polarization direction of half waveplate (P1)′, and the angle between the polarization direction of reflected light relative to the polarization axis of linear polarizer (P2). Hence the direction of the polarization axis of half waveplate (P1)′ on end face 35 can, according to this embodiment, be used as a classification characteristic of tube connector 10 and the tube connected thereto. That is, the detection of light with an intensity above a predetermined threshold can serve as a signal to a processer 260 (part of connection system 220) to activate the medical device, whereas the intensity itself can serve as a signal to processor 260 that a tube connector of a specific class has been connected and consequently effect the operation mode of the medical device.

Reference is now made to FIG. 5C which shows a flowchart illustrating the operation of the connection system of FIG. 5A, wherein the polarizing element is a linear polarizer (P1)″, according to some embodiments.

In operation, in step 500 light source 202 of connection system 220 may emit light towards end face 35 of tube connector 10 (illustrated by arrow 212 in FIG. 5A). In step 501, the emitted light optionally passes through linear polarizer (P3) thereby being converted to linearly polarized light with a polarization direction of θ (illustrated by arrow 213 in FIG. 5A). In step 502′, the light hits linear polarizer (P1)″. Only the fraction of light aligned with the polarization axis of linear polarizer (P1)″ will pass through linear polarizer (P1)″, be reflected by the reflective layer and pass back through linear polarizer (P1)″. In accordance, the intensity of the light exiting linear polarizer (P1)″ in step 503′, will depend on Malus' Law: Iₒᵤₜ=Iᵢₙ*cos² θ, wherein θ is the angle between the polarization direction of the incident light and the polarization axis of the polarizer. In step 504′ reflected light passes back through linear polarizer (P1)″. In step 505, reflected light reaches linear polarizer (P2), light detector 204 and reference light detector 208 (illustrated by arrow 214 in FIG. 5A). According to some embodiments, linear polarizer (P2) has a polarization axis which is perpendicular to the polarization axis of linear polarizer (P3). Accordingly, if for example linearly polarized light hits linear polarizer (P1)″ with a polarization angle of 45 degrees relative to the polarization axis of linear polarizer (P1)″ it exists linear polarizer (P1)″ (after being reflected by the reflective surface) with a polarization direction of 45 degrees and half the intensity. The reflected light, hits linear polarizer (P2) in a polarization angle of 45 degrees relative to the polarization axis of linear polarizer (P2) (perpendicular to linear polarizer (P3)) and will therefore exit polarizing element with a polarization direction perpendicular to incident light and with one fourth of the intensity. In effect the light intensity hitting light detector 204 is essentially dependent on the polarization axis of the linear polarizer (P1)″ and the distance L between end face 35 and light detector 204. In step 505a, the light intensity detected by light detector 204 is normalized to that detected by reference light detector 208. Processor 260 receives (from light detector 204) a signal indicative of the light intensity and determines, based on the signal received, whether or not tube connector 10 is positively identified (step 506). In case of positive identification of tube connector 10, processor 260 actuates the medical device and optionally determines the operation mode of the device (step 507). If positive identification of tube connector 10 is not determined in step 506, the medical device is not actuated.

According to this embodiment, the dependence of the light intensity detected by light detector 204 on distance L between end face 35 and light detector 204 can be excluded by normalizing the light intensity obtained by light detector 204 to that obtained by reference light detector 208. In accordance, the normalized light intensity obtained by light detector 204 is only dependent on the angle between the polarization axis of linear polarizer (P1)″ relative to the polarization direction of the linearly polarized light and to the polarization axis of linear polarizer (P2). Hence the positioning of the polarization axis of linear polarizer (P1)″ on end face 35 can according to this embodiment be used as a classification characteristic of tube connector and the tube connected thereto.

According to some embodiments connector 10 is a push-in connector. In effect, any angle of 0-90 degrees between the polarization direction of incident light and the polarization axis of linear polarizer (P1)″ will result in a light intensity detected by light detector 204 which is greater than that detected when a tube connector with a reflective layer but devoid a linear polarizer is used. In accordance the detection of light with an intensity above a predetermined threshold can serve as a signal to a processer 260 part of connection system 220 to activate the medical device and the intensity itself can serve as a signal to processor 260 that a tube connector of a specific class has been connected and consequently effect the operation mode of the medical device.

According to some embodiments, connector 10 is a radial connector. In accordance, it is understood by the skilled in the art that rotation of tube connector 10 relative to device connector 270 results in a rotation of the polarization axis of polarizing element 40 such as linear polarizer (P1)″ relative to linear polarizer (P3) and linear polarizer (P2). In effect, the light intensity detected by light detector 204 at any time during rotation depends on the relative position of the polarization axis of linear polarizer (P1)″ at that given moment. It is further understood by the skilled in the art that rotation of tube connector 10 relative to device connector 270, will cause incremental sinusoidal decreases/increases in the light intensity detected by light detector 204. According to some embodiments, connection system 220 is configured to identify tube connector 10 during its attachment to medical device connector 270 by identifying the recurring changes in the light intensity during rotation of tube connector 10 relative to device connector 270.

According to some embodiments, the recurring changes in the light intensity during rotation is different in different classes of tube connectors and depends on the distribution of first polarizing element 40 on end face 35.

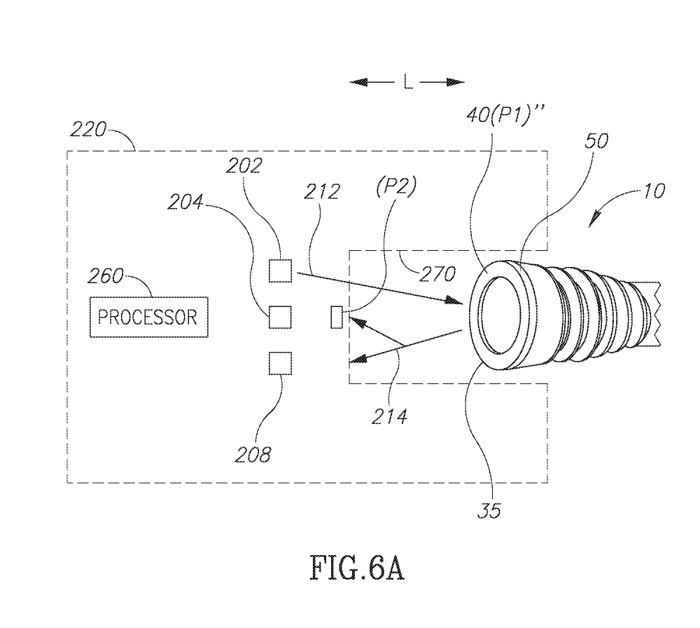

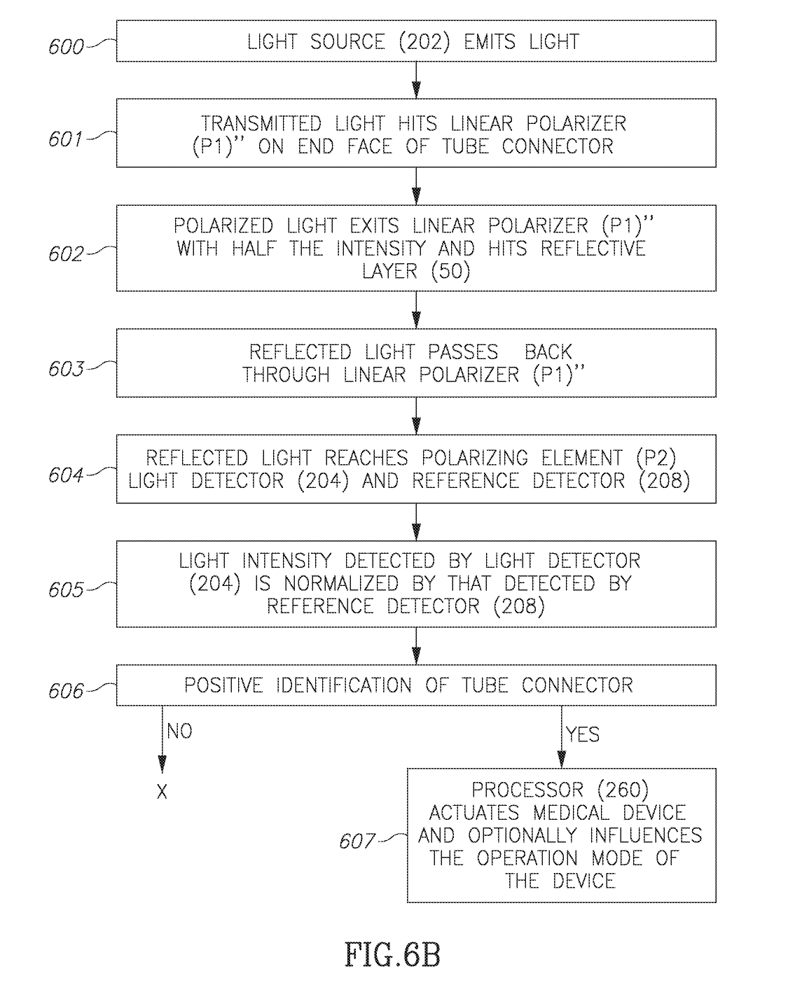

Reference is now made to FIG. 6A, which schematically illustrate a perspective view of a connector having a polarizing element disposed on an end face thereof and a block diagram of a connection system, according to some embodiments. As essentially described hereinabove, tube connector 10, includes an end face 35. End face 35 includes a first polarizing element generally referred to as (P1), (for example, a linear polarizer (P1)″ as shown herein), and a reflective layer 50. Connection system 220 of a medical device (such as a gas analyzer, for example, a capnograph) is configured to identify, authenticate, and/or specify a tube connector, according to some embodiments. Connection system 220 includes a device connector 270, one or more light sources 202; one or more light detectors 204; and a linear polarizer (P2) configured to change the polarization direction of light reflected from end face 35 of tube connector 10. As shown in FIG. 6A, connection system 220 may further include one or more reference detectors (shown as one reference detector 208).

Reference is now made to FIG. 6B, which shows a flowchart illustrating the operation of the connection system of FIG. 6A, wherein the polarizing element is a linear polarizer (P1)″, according to some embodiments.

In operation, in step 600, light source 202 of a medical device emits light towards end face 35 of tube connector 10 (illustrated by arrow 212 in FIG. 6A). In step 601, the emitted light directly hits linear polarizer (P1)″. Only the fraction of light aligned with the polarization axis of linear polarizer (P1)″ will pass through. Since incident light hitting linear polarizer (P1)″ is unpolarized light, it will exit linear polarizer (P1)″ in step 602, with half the intensity and the polarization direction parallel to the polarization axis of linear polarizer (P1)″ and be reflected by reflective surface 50 on end face 35. In step 603, reflected light will be sent back through linear polarizer (P1)″. In step 604, reflected light reaches linear polarizer (P2), light detector 204 and reference light detector 208 (illustrated by arrow 214 in FIG. 6A). In accordance, when incident light hits linear polarizer (P1)″, only the fraction of the reflected light, aligned with the polarization axis of linear polarizer (P2), will pass through linear polarizer (P2). In accordance, the intensity of the light exiting linear polarizer (P2) will depend on Malus' Law: Iₒᵤₜ=Iᵢₙ*cos² θ, wherein θ is the angle between the polarization direction of the light exiting linear polarizer (P1)″ and the polarization axis of linear polarizer (P2). In effect the light intensity hitting light detector 204 is essentially dependent on the polarization axis of linear polarizer (P1)″ relative to the polarization axis of linear polarizer (P2), and the distance L between end face 35 and light detector 204.

Furthermore, in step 605, light reflected from reflective surface 50 back through linear polarizer (P1)″ will also reach reference detector 208. In the presence of reference detector 208, the dependence of the light intensity detected by light detector 204 on distance L between end face 35 and light detector 204 can be excluded by normalizing the light intensity obtained by light detector 204 to that obtained by reference light detector 208. In accordance, the normalized light intensity obtained by light detector 204 is only dependent on the angle between the polarization axis of linear polarizer (P1)″ relative to the polarization axis of linear polarizer (P2).

Processor 260 receives (from light detector 204) a signal indicative of the light intensity and determines, based on the signal received, whether or not tube connector 10 is positively identified (step 606). In case of positive identification of tube connector 10, processor 260 actuates the medical device and optionally determines the operation mode of the device (step 607). If positive identification of tube connector 10 is not determined in step 606, the medical device is not actuated.

It is to be understood that the positioning of the polarization axis of linear polarizer (P1)″ on end face 35 according to this embodiment can be used as a classification characteristic of tube connector 10 and the tube connected thereto. In accordance, the detection of light with an intensity above a predetermined threshold can serve as a signal to a processer 260 (part of connection system 220) to activate the medical device, whereas the intensity itself can serve as a signal to processor 260 that a tube connector of a specific class has been connected and consequently effect the operation mode of the medical device.

Table 1 below summarizes the light intensities obtained when exemplary angles between the polarization axes of linear polarizer (P1)″ and linear polarizer (P2) are used.

TABLE 1

| | Relative light intensity (source/light detector) | | | |
|---|---|---|---|---|
| | Tube connector with | | Tube connector without | |
| | linear polarizer (P1)″ | | linear polarizer (P1)″ | |
| | | Reference | | Reference |
| | Main detector | detector | Main detector | detector |
| (P1)″ aligned | 0.5 | 0.5 | 0.5 | 1 |
| with (P2) | | | | |
| (P1)″ | 0 | 0.5 | 0.5 | 1 |
| perpendicular | | | | |
| to (P2) | | | | |
| (P1)″ | 0.6 | 0.5 | 0.5 | 1 |
| 20 degrees | | | | |
| rotated | | | | |
| relative to (P2) | | | | |
| (P1)″ | 0.17 | 0.5 | 0.5 | 1 |
| 70 degrees | | | | |
| rotated | | | | |
| relative to (P2) | | | | |

As seen from Table 1, a tube connector devoid of a linear polarizer on its end face maintains a constant ratio of 2 between the light intensity absorbed by a main light detector such as light detector 204 and a reference detector such as reference detector 208. In the case of a proper tube connector including a linear polarizer on its end face, the ratio depends on the polarization axis of linear polarizer of the tube connector relative to that of linear polarizer (P2).

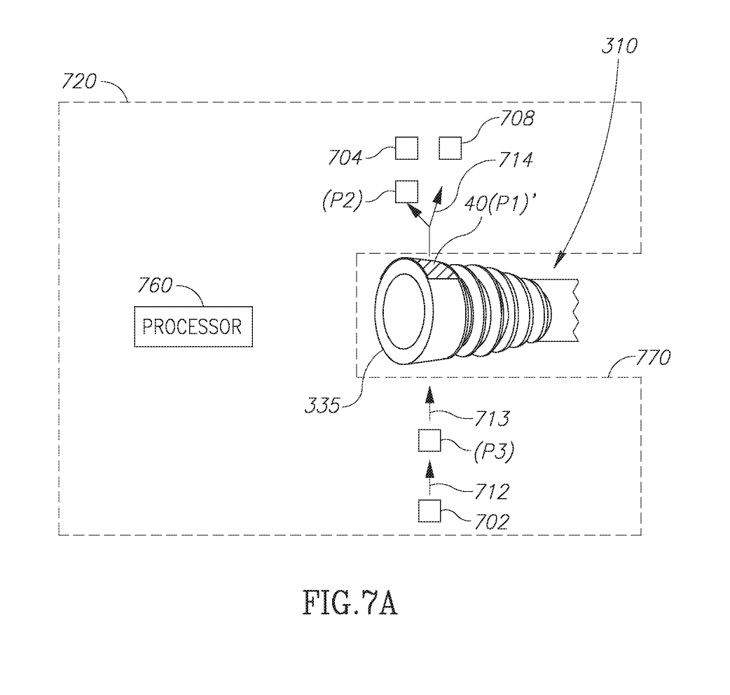

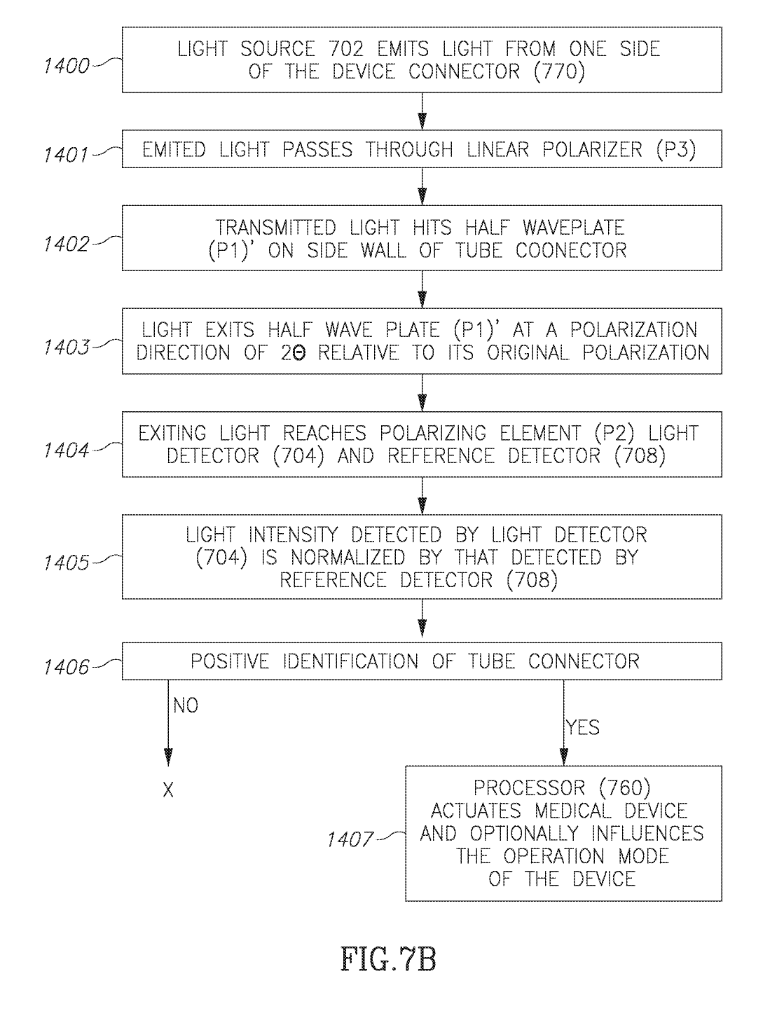

Reference is now made to FIG. 7A, which schematically illustrate a perspective view of a connector having a polarizing element disposed on an outer wall thereof and a block diagram of a connection system, according to some embodiments. As essentially described hereinabove connector 310, includes an outer wall 335 including a first polarizing element generally referred to as (P1), (for example, a half waveplate (P1)′ as shown herein). According to some embodiments, (P1) may be similar to polarizing element 340′/340″ as shown in FIGS. 3A-B. Connection system 720 of a medical device (such as a gas analyzer, for example, a capnograph) is configured to identify, authenticate, and/or specify a tube connector, according to some embodiments. Connection system 720 includes a device connector 770, and one or more light sources disposed on one side of device connector 770 (shown as one light source 702) such as for example a LED, a lamp or a laser diode. Connection system 720 further includes one or more light detectors on an opposite side of device connector 770 (shown as one light detector 704) and a polarization element such as for example linear polarizer (P2). As shown in FIG. 7A, connection system 720 may further include one or more reference detectors (shown as one reference detector 708).

Optionally, connection system 720 further includes an additional polarizing element such as for example a linear polarizer (P3) configured to convert unpolarized light from light source 702 to linearly polarized light with a polarization direction of θ. Alternatively, light source 702 is configured to emit linearly polarized light, such as for example a laser diode, with a polarization direction of θ (option not shown).

Reference is now made to FIG. 7B, which shows a flowchart illustrating the operation of the connection system of FIG. 7A, according to some embodiments.

In operation, in step 1400, light source 702 emits light from one side of device connector 770 towards outer wall 335 of tube connector 310 (illustrated by arrow 712 in FIG. 7A). In step 1401, the emitted light passes through polarizing element (P3) thereby being converted to linearly polarized light with a polarization direction of θ (illustrated by arrow 713 in FIG. 7A). In step 1402, the light hits half wave plate (P1)′. In step 1403, light exits half wave plate (P1)′ with a polarization direction of 2θ. In step 1404, light reaches linear polarizer (P2) and light detector 704 as well as reference light detector 708 on the other side of device connector 770 (illustrated by arrow 714 in FIG. 7A). According to some embodiments, linear polarizer (P2) has a polarization axis which is perpendicular to the polarization axis of linear polarizer (P3). Accordingly, if for example linearly polarized light hits half waveplate (P1)′ with a polarization angle of 45 degrees relative to the polarization axis of the half waveplate it exists half waveplate (P1)′ with a rotation of 90 degrees and will therefore be aligned with the polarization axis of linear polarizer (P2) and pass through linear polarizer (P2) essentially without loss in light intensity. In effect the light intensity hitting light detector 704 is essentially only dependent on the distance L between outer wall 335 and light detector 704.

Alternatively, if for example linearly polarized light hits half waveplate (P1)′ with a polarization angle of 22.5 degrees relative to the polarization axis of the half waveplate, it exits waveplate (P1)′ with a rotation of 45 degrees. Since only the fraction of light perpendicular to the polarization axis of linear polarizer (P2) will pass through linear polarizer (P2) it will exit linear polarizer (P2) with essentially half its intensity. In accordance, it is understood by the skilled in the art, that the light intensity hitting light detector 704 is dependent on the angle between the polarization axis of incident light and the half waveplate, the angle between the polarization axis of the half waveplate and the polarization axis of linear polarizer (P2) as well as the distance L between outer wall 335 and light detector 704.

In step 1405, the light intensity detected by light detector 704 is normalized to that detected by reference light detector 708.

Processor 760 receives (from light detector 704) a signal indicative of the light intensity and determines, based on the signal received, whether or not tube connector 310 is positively identified (step 1406). In case of positive identification of tube connector 310, processor 760 actuates the medical device and optionally determines the operation mode of the device (step 1407). If positive identification of tube connector 310 is not determined in step 1407, the medical device is not actuated.

According to this embodiment, the dependence of the light intensity detected by light detector 704 on distance L between outer wall 335 and light detector 704 can be excluded by normalizing the light intensity obtained by light detector 704 to that obtained by reference light detector 708. In accordance, the normalized light intensity detected by light detector 704 is only dependent on the angle between the polarization direction of incident light relative to the polarization axis of half waveplate (P1)′, and the angle between the polarization direction of exiting light relative to the polarization axis of linear polarizer (P2). According to some embodiments, connection system 720 is configured to identify connector 310 during its attachment to a medical device connector.

According to some embodiments, light emitted from light source 702, is passed through outer wall 335 of tube connector 310 and through first polarizing element 340′/340″ generally referred to as (P1) and subsequently detected by light detectors 704 and 708 after exiting on the other side of outer wall 335 of tube connector 310. It is understood by the skilled in the art that tube connector 310, according to this embodiment, is made of a material facilitating the transmission of the light emitted from light source 702. According to some embodiments, first polarizing element (P1) 340′/340″, is embedded within outer wall 335 of tube connector 310. According to some embodiments, tube connector 310 is made of a material able to change a polarization state of light emitted from light source 702.

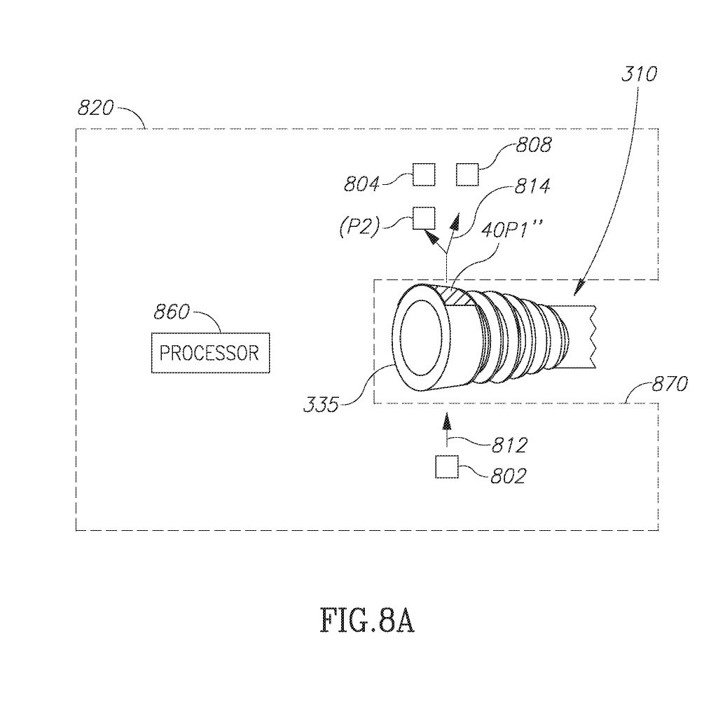

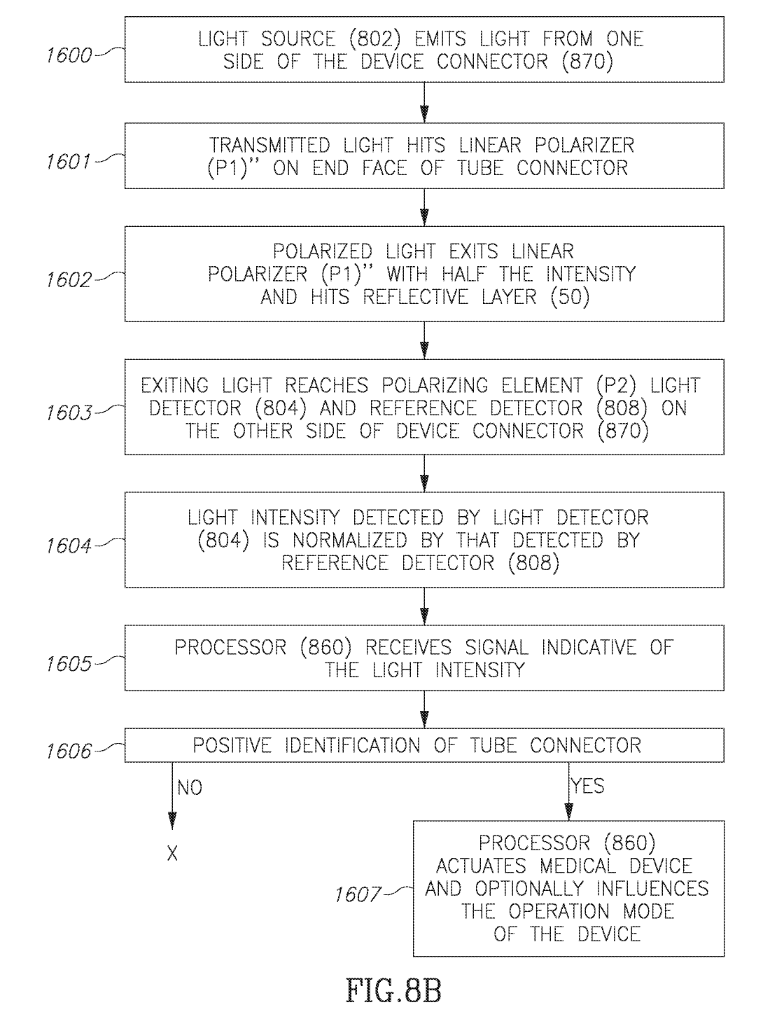

Reference is now made to FIG. 8A, which schematically illustrate a perspective view of a connector having a polarizing element disposed on an outer wall thereof and a block diagram of a connection system, according to some embodiments As essentially described hereinabove connector 310, includes an outer wall 335 including a first polarizing element generally referred to as (P1), (for example linear polarizer (P1)″ as shown herein). According to some embodiments, (P1) may be similar to polarizing element 340′/340″ as shown in FIGS. 3A-B. Connection system 820 of a medical device (such as a gas analyzer, for example, a capnograph) is configured to identify, authenticate, and/or specify a tube connector, according to some embodiments. Connection system 820 includes a device connector 870, and one or more light sources disposed on one side of device connector 870 (shown as one light source 802) such as for example a LED, a lamp or a laser. Connection system 820 further includes one or more light detectors on an opposite side of device connector 870 (shown as one light detector 804) and a polarization element such as for example linear polarizer (P2). As shown in FIG. 8A, connection system 820 may further include one or more reference detectors (shown as one reference detector 808).

Reference is now made to FIG. 8B, shows a flowchart illustrating the operation of the connection system of FIG. 8A, according to some embodiments.

In operation, in step 1600, light source 802 emits light from one side of device connector 770 towards outer wall 335 of tube connector 310. In step 1601, the emitted light directly hits linear polarizer (P1)″. Only the fraction of light aligned with the polarization axis of linear polarizer (P1)″ will pass there through. Since incident light hitting linear polarizer (P1)″ is unpolarized light, it will exit linear polarizer (P1)″, in step 1602, with half the intensity and with a polarization direction parallel to the polarization axis of linear polarizer (P1)″ and hits reflective surface 50. In step 1603, reflected light reaches linear polarizer (P2) light detector 804 and reference detector 808 on the other side of device connector 770.

In step 1604, the light intensity, detected by light detector 804, is normalized by that detected by reference detector 808. In step 1605, the normalized light intensity is used as a signal to processor 860. Processor 860 receives (from light detector 804) a signal indicative of the light intensity and determines, based on the signal received, whether or not tube connector 310 is positively identified (step 1606). In case of positive identification of tube connector 310, processor 860 actuates the medical device and optionally determines the operation mode of the device (step 1607). If positive identification of tube connector 310 is not determined in step 1606, the medical device is not actuated.

In the presence of reference detector 808, the dependence of the light intensity detected by light detector 804 on distance L between outer wall 335 and light detector 804 can be excluded by normalizing the light intensity obtained by light detector 804 to that obtained by reference light detector 808. In accordance, the normalized light intensity is only dependent on the angle between the polarization axis of the linear polarizer of polarizing element 340′/340″ relative to the polarization axis of linear polarizer (P2). In accordance, the detection of light with an intensity above a predetermined threshold can serve as a signal to processer 860 to activate the medical device, whereas the intensity itself can serve as a signal to processor 860 that a connector of a specific class has been connected and consequently affect the operation mode of the medical device.

According to this embodiment, the relative position of the polarization axis of linear polarizer (P1)″ is constant during rotation. In effect any angle of 0-90 degrees between the polarization axis of linear polarizer (P1)″ and the polarization axis of linear polarizer (P2) can be used as a classification mean of different tube connectors.

According to some embodiments, light emitted from light source 802, is passed through outer wall 335 of a tube connector 310 and through first polarizing element (P1) and subsequently detected by light detectors 804 and 808 after exiting on the other side of tube connector 310. It is understood by the skilled in the art that tube connector 310, according to this embodiment, is made of a material facilitating the transmission of the light emitted from light source 802. According to some embodiments, first polarizing element (P1) is embedded within outer wall 335 of tube connector 310. According to some embodiments, tube connector 310 is made of a material able to change a polarization state of light emitted from light source 802.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising”, when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1. A tube connector comprising at least one polarizing element (P1) arranged such that a tube connection system can identify at least one parameter of light passed through said first polarizing element.

2. The tube connector of claim 1, wherein said at least one parameter comprises presence of light, light polarization state, light polarization direction, light intensity or combinations thereof.

3. The tube connector of claim 1, wherein said at least one parameter is indicative of a preferred mode of operation of said tube connector.

4. The tube connector of claim 1, wherein said connection system is further configured to identify changes in said at least one parameter during insertion and/or revolving of said tube connector relative to a device connector.

5. The tube connector of claim 1, wherein said at least one polarizing element (P1) is positioned on an end face of said tube connecter.

6. The tube connector of claim 1, wherein said at least one polarizing element (P1) is positioned on an outer wall of said tube connecter.

7. The tube connector of claim 1, wherein said at least one polarizing element (P1) is attached to, embedded in or molded on said tube connecter.

8. The tube connector of claim 1, wherein said at least one polarizing element (P1) is a waveplate.

9. The tube connector of claim 8, wherein said waveplate is a half waveplate.

10. The tube connector of claim 1, wherein said at least one polarizing element (P1) comprises a linear polarizer.

11. The tube connector of claim 10, wherein said linear polarizer is configured to transmit light parallel to a polarization axis of said linear polarizer and to block light perpendicular to said polarization axis.

12. The tube connector of claim 10, wherein said at least one linear polarizer comprises a radially distributed polarizer.

13. The tube connector of claim 1, further comprising a reflective layer arranged such that said connection system can identify light passed through said first polarizing element and reflected by said reflective layer.

14. A method comprising:
forming a tube connector; and
applying at least one polarizing element, such that a tube connection system can identify at least one parameter of light passing therethrough

15. The method of claim 14, further comprising applying a reflective layer between an end face of the tube connector and the at least one polarizing element.

16. The method of claim 15 wherein applying comprises attaching, molding, embedding or depositing the at least one polarizing element and/or the reflective layer on the tube connector.

17. The method of claim 15, wherein the at least one polarizing element and/or the reflective layer is applied on an end face of the tube connector.

18. The method of claim 15, wherein the at least one polarizing element and/or the reflective layer is applied on an outer wall of the tube connector.

19. A method for identifying connection of a tube connector to a device connector, the method comprising:
inserting a tube connector into a device connector;
transmitting polarized light of a first polarization toward at least one polarizing element positioned on the tube connector; and
detecting, using a light detector, at least one parameter of light having passed through the at least one polarizing element.

20. The method of claim 19, further comprising activating the medical device when the at least one parameter is detected.
